(19) United States
(12) Patent Application Publication
(10) Pub. No.: US 2026/0068893 A1
(43) Pub. Date: Mar. 12, 2026

(54) TANGZHONG COMPRISING POWDERED RICE, BREAD DOUGH COMPRISING SAME AND BREAD MANUFACTURED USING SAME

(71) Applicant: CJ FOODVILLE CORP., Seoul (KR)

(72) Inventor: Songi KIM, Suwon-si Gyeonggi-do (KR)

(73) Assignee: CJ FOODVILLE CORP., Seoul (KR)

(21) Appl. No.: 19/316,187

(22) Filed: Sep. 2, 2025

(30) Foreign Application Priority Data
Sep. 6, 2024 (KR) 10-2024-0121724
Apr. 3, 2025 (KR) 10-2025-0043737

(51) Int. Cl. A21D 13/40; A21D 2/18; A21D 2/34; A21D 6/00; A21D 8/02

(52) U.S. Cl. CPC A21D 13/40; A21D 2/181; A21D 2/34; A21D 6/00; A21D 8/02

(57) ABSTRACT

The present disclosure relates to a tangzhong comprising powdered rice, a bread dough comprising the tangzhong, and a bread prepared using the same. In the present disclosure, a tangzhong is prepared using powdered rice, glutinous rice flour, and water, thereby enabling the production of a tangzhong having a soft, moist, and chewy texture compared to tangzhong prepared using wheat flour. In addition, when the tangzhong of the present disclosure is used to prepare bread dough, the resulting dough exhibits high moisture retention and a slow staling rate, and the bread prepared from the dough may have a high rice content and density, with a moist and chewy texture and delayed staling.

### CROSS-REFERENCE TO RELATED APPLICATIONS

This application claims the priority to Korean Patent Application Nos. 10-2024-0121724 and 10-2025-0043737 filed on Sep. 6, 2024, and Apr. 3, 2025, respectively, in the Korean Intellectual Property Office, the disclosure of which is incorporated herein by reference.

### BACKGROUND

### Field

The present disclosure relates to a tangzhong comprising powdered rice, a bread dough comprising the tangzhong, and a bread prepared using the same, and more specifically, to a tangzhong prepared by mixing powdered rice and glutinous rice flour with water, a bread dough comprising the tangzhong, and bread prepared using the same.

### Description of the Related Art

Bread is a product prepared by mixing basic ingredients such as wheat flour, yeast, water, and salt in a kneader to develop gluten, allowing the dough to expand through yeast fermentation, and baking the dough using a pan. Depending on the type, differences exist in the form of dough, fermentation, and baking process. Tangzhong is a gel-like mixture prepared by heating wheat flour and water, and is added to bread dough to enhance the flavor and texture of the bread and to delay staling.

When bread is prepared using tangzhong, a greater amount of moisture can be incorporated into the dough, resulting in moister bread with a softer and fluffier texture. Bread prepared with tangzhong may exhibit a longer shelf life compared to conventional bread. For this reason, tangzhong has been used in the preparation of various types of bread such as red bean bread, streusel bread, and milk bread, and has recently been applied to an increasing number of bread types.

In this regard, Korean Patent No. 10-2535786 relates to a non-greasy handmade croquette and a method for preparing the same, and discloses a method of preparing a croquette using a more diluted tangzhong by adjusting the weight ratio of wheat flour to water, thereby providing a moist and chewy texture while preventing oil from being excessively absorbed into the bread after frying, thus maintaining softness and moistness for an extended period of time.

In addition, Korean Patent No. 10-2202151 relates to a method for preparing white bread, and discloses a method for improving the coarse texture of organic wheat flour by utilizing only the advantages of various types of doughs, including tangzhong dough prepared by cooking and kneading wheat flour, poolish dough prepared using the poolish method, sponge dough, and sourdough dough using raisin yeast.

However, tangzhong prepared using wheat flour tends to rely excessively on gluten characteristics, resulting in a chewy but monotonous texture and presenting limitations in achieving diverse crumb structures. Furthermore, the gluten network gradually hardens over time, leading to rapid moisture loss from the dough and causing the final product to harden quickly. In particular, the structure is easily damaged during freezing and thawing processes, and after thawing, the appearance and texture of the product may deteriorate, exhibiting crumbliness or mushiness and resulting in a significant loss of quality. Such physical instability can serve as a major factor that undermines consumer preference and marketability during long-term storage and distribution.

Accordingly, the inventors of the present disclosure have developed a tangzhong prepared without wheat flour using powdered rice, and have confirmed that the tangzhong enables the production of bread having a moist and chewy texture, high moisture retention, and a slow staling rate, thereby completing the present disclosure.

### SUMMARY

An object of the present disclosure is to provide a tangzhong capable of improving the flavor, texture, and cross-sectional structure of bread.

Another object of the present disclosure is to provide a bread dough comprising the tangzhong.

Still another object of the present disclosure is to provide bread prepared using the bread dough.

In order to achieve the above objects, the present disclosure provides a tangzhong comprising a gelatinized mixture obtained by mixing and heating powdered rice, glutinous rice flour, and water.

In the tangzhong of the present disclosure, an amount of the glutinous rice flour may be 17 to 33 parts by weight based on 100 parts by weight of the powdered rice.

In the tangzhong of the present disclosure, an amount of the water may be 400 to 500 parts by weight based on 100 parts by weight of the powdered rice.

In the tangzhong of the present disclosure, a weight ratio of the glutinous rice flour to the powdered rice may be 1:1.5 to 1:8.

The present disclosure also provides a bread dough comprising wheat flour, powdered rice, yeast, and the tangzhong, wherein the tangzhong comprises a gelatinized mixture obtained by mixing and heating powdered rice, glutinous rice flour, and water.

In the bread dough of the present disclosure, an amount of the tangzhong may be 24 to 42 parts by weight based on 100 parts by weight of the wheat flour.

In the bread dough of the present disclosure, an amount of the powdered rice may be 4 to 18 parts by weight based on 100 parts by weight of the wheat flour.

In the bread dough of the present disclosure, the bread dough may further comprise at least one ingredient selected from the group consisting of sugar, salt, butter, powdered milk, shortening, improver, and fermenting sugar.

The present disclosure further provides a bread prepared using the bread dough.

In the present disclosure, the bread may be at least one selected from the group consisting of white bread, bagel, brioche, sweet bread, twisted bread, yeast donut, Mont Blanc, butter roll, pizza crust, and cheese stick.

The present disclosure also provides a method for preparing a tangzhong, comprising (i) preparing a mixture by adding powdered rice and glutinous rice flour to water; and (ii) preparing a gelatinized dough by heating the mixture.

The method of the present disclosure may further comprise aging the prepared tangzhong.

In the method of the present disclosure, a heating temperature in step (ii) may be 50 to 100° C.

In the method of the present disclosure, the heating in step (ii) may be performed while stirring the mixture, and the stirring may be performed at 100 to 800 rpm.

In the method of the present disclosure, the stirring may be performed for 30 to 40 minutes.

In the method of the present disclosure, the aging of the tangzhong may be performed at −5 to 15° C. for 20 to 120 hours.

In the present disclosure, by preparing a tangzhong using powdered rice, glutinous rice flour, and water, it is possible to produce a tangzhong that has a soft, moist, and chewy texture compared to tangzhong prepared using wheat flour. In addition, when the tangzhong of the present disclosure is used to prepare a bread dough, the resulting dough exhibits high moisture retention and a slow staling rate. Furthermore, bread prepared using the bread dough may have a high rice content and density, and exhibit a moist and chewy texture with delayed staling.

### BRIEF DESCRIPTION OF THE DRAWINGS

FIG. 1 shows a photograph of the tangzhong prepared according to one embodiment of the present disclosure.

FIG. 2a shows a photograph of the dough of a rice bagel prepared according to one embodiment of the present disclosure.

FIG. 2b shows a photograph of the rice bagel prepared according to one embodiment of the present disclosure.

FIG. 3a shows a photograph of the dough of an olive bagel prepared according to one embodiment of the present disclosure.

FIG. 3b shows a photograph of the olive bagel prepared according to one embodiment of the present disclosure.

### DETAILED DESCRIPTION OF THE INVENTION

Hereinafter, specific embodiments of the present disclosure will be described in more detail. Unless otherwise defined, all technical and scientific terms used in the present specification have the same meanings as commonly understood by those skilled in the art to which the present disclosure pertains. In general, the nomenclature used in the present specification is well known and commonly used in the relevant technical field.

The present disclosure relates to a tangzhong comprising powdered rice. In the present disclosure, a tangzhong is prepared using powdered rice, glutinous rice flour, and water, thereby enabling the production of a tangzhong having a soft, moist, and chewy texture compared to tangzhong prepared using wheat flour. The tangzhong prepared in the present disclosure may be referred to as “K-Rice Paste.”

The tangzhong of the present disclosure may comprise powdered rice, glutinous rice flour, and water, and more specifically, may comprise a gelatinized mixture obtained by mixing and heating powdered rice, glutinous rice flour, and water.

Unlike conventional tangzhong prepared by mixing water and wheat flour, in the present disclosure, tangzhong is prepared using powdered rice and glutinous rice flour, and bread is prepared using the tangzhong, thereby enabling the production of bread having a moist texture and a clean, easy-to-tear bite.

In the present disclosure, “powdered rice” refers to a newly developed rice variety (Baromi 2) created under the supervision of the Korean Ministry of Agriculture, Food and Rural Affairs to enhance domestic food self-sufficiency and promote mutual prosperity with farming communities. Unlike general rice, this variety has a starch structure similar to that of wheat, making it suitable for use in a wide range of food applications.

The powdered rice and glutinous rice flour have a higher amylopectin content compared to wheat flour, allowing for the production of intermediate and final products with lower hardness and a softer texture. However, powdered rice generally does not contain gluten and is therefore unsuitable for conventional bread making.

Nevertheless, when powdered rice is gelatinized through a heating process and used in the form of tangzhong for bread making, the starch swells and forms a gel-like viscosity, which enhances water retention and stabilizes the structure. As a result, even when powdered rice is added, the dough structure can be improved.

Accordingly, the use of the tangzhong of the present disclosure allows for an increased rice content while providing excellent texture, and at the same time, enhances the dough's moisture retention, thereby preventing staling.

In the present disclosure, glutinous rice flour is used in combination with powdered rice as a tangzhong ingredient. When only powdered rice is used in the preparation of tangzhong, insufficient viscosity (moisture retention) may lead to slack consistency during the preparation of intermediate products and spreading in the appearance of the final product. However, such issues can be resolved by blending glutinous rice flour with powdered rice. However, if the content of glutinous rice flour is too high, the viscosity may become excessive, resulting in poor workability, and the elasticity may decrease, reducing structural stability.

From this perspective, the weight ratio of glutinous rice flour to powdered rice comprised in the tangzhong of the present disclosure may be 1:1.5 to 1:8, preferably 1:2 to 1:6, more preferably 1:3 to 1:5. Within this range, the tangzhong can exhibit appropriate viscosity and elasticity suitable for dough preparation, and bread prepared using such tangzhong may exhibit excellent appearance, flavor, and texture.

In one embodiment of the present disclosure, as a result of comparing the physical properties of tangzhong prepared by adjusting the weight ratio of glutinous rice flour to powdered rice, it was confirmed that when they are blended at a specific weight ratio, the resulting tangzhong exhibits appropriate viscosity and elasticity, enabling the preparation of dough with suitable blending characteristics, and the bread produced from the dough shows excellent appearance, flavor, and texture due to the optimal combination of glutinous rice flour and powdered rice.

In the tangzhong of the present disclosure, the glutinous rice flour may be comprised in an amount of 17 to 33 parts by weight, preferably 20 to 30 parts by weight, more preferably 23 to 27 parts by weight, based on 100 parts by weight of the powdered rice. Water may be comprised in an amount of 400 to 500 parts by weight, preferably 420 to 460 parts by weight, more preferably 430 to 445 parts by weight, based on 100 parts by weight of the powdered rice.

When the amounts of the glutinous rice flour and water fall within the above ranges relative to the amount of powdered rice comprised in the tangzhong, the tangzhong may exhibit excellent moisture retention.

Meanwhile, the water used in the preparation of the tangzhong of the present disclosure may be purified water.

The tangzhong of the present disclosure may be prepared by mixing and heating the powdered rice, glutinous rice flour, and water.

Specifically, the tangzhong of the present disclosure is prepared by performing the following steps: preparing a mixture by adding powdered rice and glutinous rice flour to water; and preparing a gelatinized dough by heating the mixture.

First, after adding powdered rice and glutinous rice flour to water to form a mixture, a step of forming a vacuum may be performed by reducing the pressure to −900 to −500 mbar, preferably-800 to −600 mbar.

Next, a step of preparing a gelatinized dough by heating the mixture to 50 to 100° C., preferably 60 to 95° C., more preferably 70 to 90° C. is performed, and after reaching the target temperature, the heating may be maintained at the target temperature for 100 to 500 seconds, preferably 200 to 400 seconds, more preferably 250 to 350 seconds.

The heating may be performed while stirring the mixture, and specifically, stirring may be performed at 100 to 800 rpm, preferably 200 to 400 rpm, for 30 to 40 minutes, preferably 10 to 20 minutes.

After heating, a step of aging the prepared gelatinized dough at low temperature may be performed, and specifically, the gelatinized dough may be stored at −5 to 15° C., preferably 0 to 10° C., for 20 to 120 hours, preferably 40 to 100 hours, for aging.

It is preferable that the tangzhong thus prepared be used within 7 days from the date of preparation.

The present disclosure may also provide a bread dough comprising the tangzhong and bread prepared using the same. By using the tangzhong of the present disclosure, it is possible to produce bread that has a moist and chewy texture, exhibits excellent flavor, and shows a slow staling rate.

In particular, by using the tangzhong of the present disclosure, bread may be prepared that maintains a moist and chewy texture for an extended period, retains a subtle rice flavor, and exhibits high moisture retention and a slow staling rate. The bread of the present disclosure may be at least one selected from the group consisting of white bread, bagel, brioche, sweet bread, twisted bread, yeast donut, Mont Blanc, butter roll, pizza crust, and cheese stick, and preferably may be a bagel.

Specifically, bagels are characterized by a dense crumb and chewy crust, and are typically prepared through a boiling process to achieve their unique internal structure and texture. However, by using the tangzhong of the present disclosure, bagels having a dense crumb and a chewy yet not tough crust can be prepared without the boiling process.

Generally, products sold as rice bagels are made using premixes containing food additives such as gluten, which can diminish the natural rice flavor. In contrast, the present disclosure enables the preparation of bagels that exhibit a subtle rice flavor, excellent texture, and slow staling, without the need for food additives, by using a tangzhong comprising powdered rice and glutinous rice flour.

Specifically, in the present disclosure, a bread dough may be prepared by blending water into dough ingredients comprising wheat flour, powdered rice, yeast, and the tangzhong, followed by baking to prepare the bread. The bread dough may further comprise at least one ingredient selected from the group consisting of sugar, salt, butter, powdered milk, shortening, improver, and fermenting sugar.

In a preferred embodiment of the present disclosure, the bread dough may be dough for bagels. The wheat flour used in the bread dough may include at least one baking flour selected from strong flour, medium flour, whole wheat flour, rye flour, and bran flour. Preferably, the bread dough for fermented bread may comprise strong flour.

In the present disclosure, the powdered rice may be comprised in an amount of 4 to 18 parts by weight, preferably 6 to 16 parts by weight, more preferably 8 to 14 parts by weight, based on 100 parts by weight of the wheat flour used in the dough. When the powdered rice content falls within the above range, it is possible to produce bread that has a subtle rice flavor.

In the bread dough of the present disclosure, the tangzhong may be comprised in an amount of 24 to 42 parts by weight, preferably 27 to 39 parts by weight, more preferably 30 to 36 parts by weight, based on 100 parts by weight of the wheat flour. When the content of tangzhong is too high, mixing stability may be reduced, fermentation and baking times may be delayed, and the dough may exhibit reduced rise due to excess moisture. Conversely, if the tangzhong content is too low, moisture retention may be insufficient, resulting in faster staling, deteriorated texture, and diminished rice flavor.

In one embodiment of the present disclosure, as a result of comparing the physical properties of bread prepared by adjusting the tangzhong content, it was confirmed that when the tangzhong is comprised in a specific amount, the dough does not exhibit stickiness during ingredient blending and division, and the resulting bread exhibits an appetizing appearance, a chewy and moist texture, and a subtle rice flavor.

Meanwhile, the yeast serves to promote fermentation and add volume to the bread, and may be comprised in an amount of 0.5 to 5 parts by weight, preferably 1 to 3 parts by weight, based on 100 parts by weight of the wheat flour, in consideration of the flavor and fermentability of the bread.

The sugar is an ingredient added to promote fermentation by serving as a substrate for sugar breakdown in the dough, and may be comprised in an amount of 4 to 9 parts by weight, preferably 5 to 8 parts by weight, based on 100 parts by weight of the wheat flour.

The salt not only imparts flavor to the bread but also reinforces the gluten structure, increases bread volume, and plays a role in controlling the fermentation rate. The salt may be comprised in an amount of 0.5 to 5 parts by weight, preferably 1 to 3 parts by weight, based on 100 parts by weight of the wheat flour.

The powdered milk is an ingredient that enhances the flavor of bread and helps with moisture retention and browning of the dough, and may be comprised in an amount of 0.5 to 5 parts by weight, preferably 1 to 3 parts by weight, based on 100 parts by weight of the wheat flour.

The improver is an ingredient that increases the dough's elasticity and gas retention capacity, thereby improving the bread's volume and texture. The improver may be comprised in an amount of 0.1 to 3 parts by weight, preferably 0.5 to 1.5 parts by weight, based on 100 parts by weight of the wheat flour.

The shortening is an ingredient that imparts softness and a crisp texture to the dough. The shortening may be comprised in an amount of 5 to 13 parts by weight, preferably 7 to 11 parts by weight, based on 100 parts by weight of the wheat flour.

The fermented sugar is an ingredient that serves as a nutrient source for the yeast to promote fermentation and enhance the flavor and browning of the bread. The fermented sugar may be comprised in an amount of 0.5 to 5 parts by weight, preferably 1 to 3 parts by weight, based on 100 parts by weight of the wheat flour.

In a preferred embodiment of the present disclosure, the bread dough may be dough for bagels. The bread dough may further comprise auxiliary ingredients for various flavors, such as olives, dried fruits, chocolate, and nuts. The auxiliary ingredients may be blended in an amount that does not interfere with fermentation or texture of the bread, for example, in an amount of 20 parts by weight or less based on 100 parts by weight of the wheat flour.

The above ingredients may be mixed with water to prepare the bread dough. The water may be comprised in an amount of 28 to 48 parts by weight, preferably 30 to 45 parts by weight, based on 100 parts by weight of the wheat flour.

During the preparation of the bread dough in the present disclosure, the core maintenance temperature may be 13 to 21° C., preferably 15 to 18° C., and the dough temperature may be 16 to 24° C., preferably 18 to 22° C.

In the present disclosure, the bread dough may be prepared by mixing the above ingredients, followed by dividing and shaping, and then stored by rapid freezing. The rapid freezing temperature may be −40 to −30° C., preferably-37 to −33° C., and after freezing, the core temperature of the dough may be −12 to −4° C., preferably-10 to −6° C. The storage temperature may be −22 to ˜14° C., preferably-20 to ˜16° C.

During bread preparation, the dough may be thawed and baked to produce bread. Prior to baking, the bread dough may be subjected to shaping, panning, and fermentation processes.

### Examples

The present disclosure will be described in more detail below with reference to Examples. However, these Examples are provided solely for illustrative purposes to describe certain experimental methods and compositions, and the scope of the present disclosure is not limited thereto.

### Preparation Example 1: Preparation of Tangzhong Comprising Powdered Rice and Glutinous Rice Flour

Tangzhong was prepared by mixing 25 parts by weight of glutinous rice flour and 437.5 parts by weight of purified water with 100 parts by weight of soft-type powdered rice.

First, powdered rice and glutinous rice flour were added to purified water at the above proportions in a stirrer to prepare a mixture, and the pressure was reduced to −700 mbar.

Then, the mixture was heated while stirring at a speed of 300 rpm for 15 minutes until the temperature reached 80° C., and heating was maintained at 80° C. for 300 seconds to prepare the tangzhong.

The prepared tangzhong was packaged and stored for 72 hours at 0 to 10° C. in a refrigerated warehouse for aging.

A photograph of the tangzhong thus prepared is shown in FIG. 1.

### Preparation Example 2: Preparation of Rice Bagel Using the Tangzhong

A rice bagel was prepared using the tangzhong of Preparation Example 1. Bread dough was prepared by weighing and mixing the ingredients at the weight ratios shown in Table 1 below. The ingredients were measured while maintaining the core temperature of fats at approximately 15 to 18° C.

TABLE 1

| ingredients | weight ratios |
|---|---|
| strong wheat flour | 90.00 |
| soft-type powdered rice | 10.00 |
| refined salt | 1.80 |
| low-sugar frozen dough yeast | 1.80 |
| white sugar | 6.00 |
| skimmed milk powder | 2.00 |
| bread improver | 1.00 |
| shortening | 8.00 |
| tangzhong of Preparation Example 1 | 30.00 |
| rice-fermenting sugar | 2.00 |
| purified water | 38.50 |

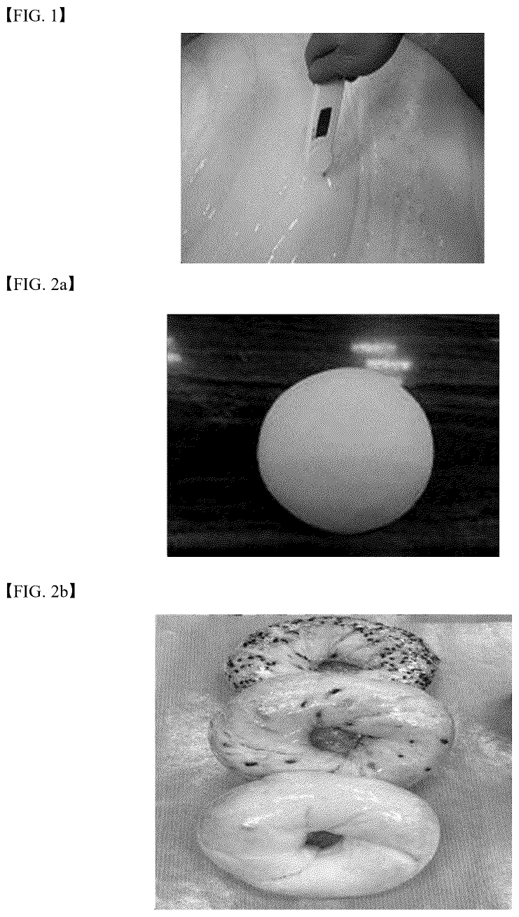

The bread dough was mixed while maintaining a dough temperature of 20.0±1.5° C., divided into approximately 132 g portions, and shaped into dimensions of approximately 75 mm in length, 75 mm in width, and 45 mm in thickness. The shaped dough was then rapidly frozen at −35° C. for 30 minutes until the core temperature reached-8±2° C., followed by metal detection and packaging, and stored in a frozen warehouse at −18° C. or below. A photograph of the prepared dough is shown in FIG. 2a.

To prepare the bagels from the frozen dough, the dough was thawed until the core temperature reached 8° C., fermented at 20° C. and 75% humidity for 30 to 40 minutes, and then baked in an oven set to 220° C. (top) and 180° C. (bottom) for approximately 10 minutes. A photograph of the final rice bagel product is shown in FIG. 2b.

The resulting rice bagel exhibited a subtle rice flavor and sweetness, and showed a moist, chewy, yet easy-to-bite texture. These results confirm that by using the tangzhong of the present disclosure, it is possible to produce bread that demonstrates excellent consumer appeal in both flavor and texture.

### Preparation Example 3: Preparation of Olive Bagel Using the Tangzhong

An olive bagel was prepared using the tangzhong of Preparation Example 1. The bread dough was prepared by weighing and mixing the ingredients at the weight ratios shown in Table 2 below. The ingredients were measured while maintaining the core temperature at approximately 15 to 18° C., and olives that had been dehydrated and stored under refrigeration 48 hours prior to mixing were used.

TABLE 2

| ingredients | weight ratios |
|---|---|
| strong wheat flour | 90.00 |
| soft-type powdered rice | 10.00 |
| refined salt | 1.80 |
| low-sugar frozen dough yeast | 1.80 |
| white sugar | 6.00 |
| skimmed milk powder | 2.00 |
| bread improver | 1.00 |
| shortening | 8.00 |
| tangzhong of Preparation Example 1 | 30.00 |
| rice-fermenting sugar | 2.00 |
| purified water | 30.77 |
| sliced black olives | 16.00 |

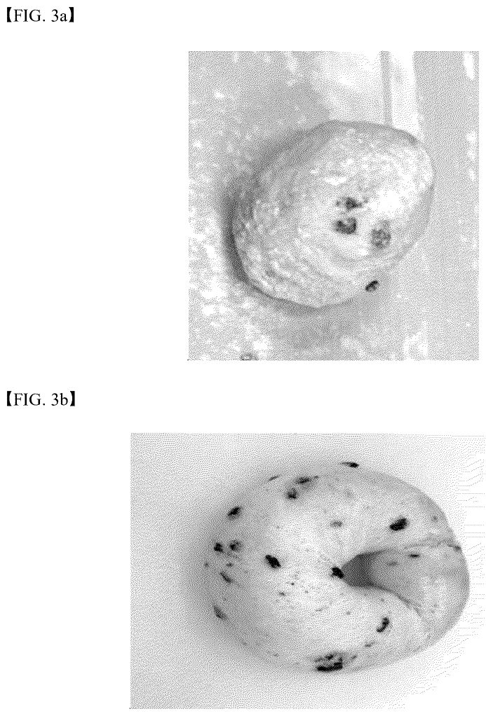

The bread dough was mixed while maintaining a dough temperature of 20.0±1.5° C., divided into approximately 132 g portions, and shaped to have a length, width, and thickness of approximately 75 mm, 75 mm, and 45 mm, respectively. The shaped dough was then rapidly frozen at −35° C. for 30 minutes until the core temperature reached-8±2° C., followed by metal detection and packaging, and stored in a frozen warehouse at −18° C. or below. A photograph of the prepared dough is shown in FIG. 3a.

To prepare the bagels from the frozen dough, the dough was thawed until the core temperature reached 8° C., fermented at 20° C. and 75% humidity for 30 to 40 minutes, and then baked in an oven set to 220° C. (top) and 180° C. (bottom) for approximately 10 minutes. A photograph of the final rice bagel product is shown in FIG. 3b.

The resulting olive bagel, like the rice bagel of Preparation Example 2, exhibited a subtle rice flavor and sweetness, and had a moist, chewy, yet easy-to-bite texture, confirming that bread with excellent consumer preference in both flavor and texture can be produced using the tangzhong of the present disclosure.

### Experimental Example 1: Comparison of Bread Properties According to the Ratio of Powdered Rice to Glutinous Rice Flour

Tangzhong was prepared in the same manner as in Preparation Example 1, except that the weight ratios of powdered rice to glutinous rice flour were adjusted to 5:0, 4:1, and 3:2, respectively. Using the tangzhong thus prepared, three types of bagels were produced in the same manner as in Preparation Example 2.

When the tangzhong was prepared with a powdered rice to glutinous rice flour weight ratio of 4:1, the tangzhong exhibited suitable viscosity and elasticity for incorporation into dough, without being excessively thin or stiff. The resulting bagel, prepared using this tangzhong, exhibited a subtle sweetness characteristic of proper gelatinization of powdered rice and glutinous rice flour, as well as a moist, chewy, yet easy-to-bite texture. Bagels with excellent appearance, crumb structure, and texture were successfully obtained.

In contrast, when the tangzhong was prepared without glutinous rice flour, the tangzhong had high moisture content and low elasticity, resulting in a lack of structural stability when added to the dough. As the heating time increased, particle swelling and breakdown intensified, giving the tangzhong a looser consistency. The bagel produced using this tangzhong showed a flattened shape and an overly soft texture, deviating from the desired sensory characteristics.

Meanwhile, when the tangzhong was prepared with a powdered rice to glutinous rice flour weight ratio of 3:2, although the heating time was short, the gelatinization stability was low. The prepared dough quickly firmed up during refrigerated storage, indicating a fast staling rate. As a result, the bagel showed a decrease in volume and exhibited a dense, sticky crumb texture.

These results confirmed that by adjusting the weight ratio of powdered rice to glutinous rice flour in the tangzhong, it is possible to produce bread exhibiting excellent appearance, crumb structure, and texture.

### Experimental Example 2: Comparison of Bread Properties According to Tangzhong Input Ratio

Rice bagels were prepared in the same manner as in Preparation Example 2, except that the input weight ratio of tangzhong was adjusted to 10 and 50, respectively. The properties of the resulting rice bagels were compared with those of the rice bagel prepared in Preparation Example 2.

First, the bagel of Preparation Example 2 exhibited no stickiness during ingredient blending and division, making the dough easy to handle. In contrast, when the tangzhong input weight ratio was 10, the dough lacked moisture, requiring an increased amount of purified water during mixing. When the tangzhong input weight ratio was 50, the dough became sticky and slack, with a tendency to adhere to the inner wall of the mixing bowl, resulting in inconsistent dough temperature and extended baking time due to the high moisture content.

Next, the appearance, texture, and flavor of the prepared bagel dough and final bagels were compared. The bagel of Preparation Example 2 exhibited an optimal balance of properties such as viscosity, elasticity, and moisture retention, allowing for the natural formation of a characteristic ring shape and stable appearance during shaping and baking. The bagel also showed a subtle rice flavor and natural sweetness, with a moist, chewy, and easily chewable texture, resulting in an overall excellent flavor balance. Furthermore, moisture retention was sustained over time, and the staling rate remained low, ensuring stable quality during storage.

In contrast, the bagel prepared with a tangzhong input weight ratio of 10 lacked the desired moist and chewy texture, and the subtle rice flavor was diminished. Additionally, the staling rate progressed relatively quickly during extended storage.

Meanwhile, when the tangzhong input weight ratio was 50, the dough was overly slack, causing it to stick to the palms or work surface during shaping, which led to inconsistencies in the appearance of the final product. During baking, oven spring was minimal, and the long baking time resulted in a tough texture and a pale, uneven crust. Moreover, the final bagel exhibited a raw wheat flour odor and a sticky, dense texture.

These results confirmed that, by appropriately adjusting the tangzhong content during bagel preparation, it is possible to produce bread exhibiting excellent appearance, crumb structure, and texture.

From the above description, those skilled in the art will understand that the present disclosure may be implemented in other specific forms without departing from the technical spirit or essential characteristics thereof. Accordingly, the embodiments described above are to be understood in all respects as illustrative and not restrictive.

What is claimed is:

1. A tangzhong comprising a gelatinized mixture obtained by mixing and heating powdered rice, glutinous rice flour and water.

2. The tangzhong of claim 1,
wherein an amount of the glutinous rice flour is 17 to 33 parts by weight based on 100 parts by weight of the powdered rice.

3. The tangzhong of claim 1,
wherein an amount of the water is 400 to 500 parts by weight based on 100 parts by weight of the powdered rice.

4. The tangzhong of claim 1,
wherein a weight ratio of the glutinous rice flour to the powdered rice is 1:1.5 to 1:8.

5. A bread dough comprising wheat flour, powdered rice, yeast and a tangzhong,
wherein the tangzhong comprises a gelatinized mixture obtained by mixing and heating powdered rice, glutinous rice flour and water.

6. The bread dough of claim 5,
wherein an amount of the tangzhong is 24 to 42 parts by weight based on 100 parts by weight of the wheat flour.

7. The bread dough of claim 5,
wherein an amount of the powdered rice is 4 to 18 parts by weight based on 100 parts by weight of the wheat flour.

8. The bread dough of claim 5,
wherein the bread dough further comprises at least one ingredient selected from the group consisting of sugar, salt, butter, powdered milk, shortening, improver and fermenting sugar.

9. A bread prepared using the bread dough of claim 5.

10. The bread of claim 9,
wherein the bread is at least one selected from the group consisting of white bread, bagel, brioche, sweet bread, twisted bread, yeast donut, Mont Blanc, butter roll, pizza crust and cheese stick.

11. A method for preparing a tangzhong, comprising the steps of:
(i) preparing a mixture by adding powdered rice and glutinous rice flour to water, and
(ii) preparing a gelatinized dough by heating the mixture.

12. The method of claim 11,
further comprising a step of aging the prepared tangzhong.

13. The method of claim 11,
wherein a heating temperature in step (ii) is 50 to 100° C.

14. The method of claim 11,
wherein the heating in step (ii) is performed while stirring the mixture,
and the stirring is performed at 100 to 800 rpm.

15. The method of claim 14,
wherein the stirring is performed for 30 to 40 minutes.

16. The method of claim 12,
wherein the aging of the tangzhong is performed at −5 to 15° C. for 20 to 120 hours.
